(19) United States
(12) Patent Application Publication
(10) Pub. No.: US 2019/0325654 A1
(43) Pub. Date: Oct. 24, 2019

(54) AUGMENTED REALITY COMMON OPERATING PICTURE

(71) Applicant: BAE Systems Information and Electronic Systems Integration Inc., Nashua, NH (US)

(72) Inventors: Karissa M. Stisser, Merrimack, NH (US); Christopher R. Cummings, Vestal, NY (US); John J. Kelly, Groton, MA (US); Fran A. Piascik, Auburn, NH (US); William R. Samuels, Wilton, NH (US); Michelle R. Wingert, Nashua, NH (US)

(21) Appl. No.: 15/961,053

(22) Filed: Apr. 24, 2018

(51) Int. Cl. G06T 19/00; G06T 3/40; H04L 29/06

(52) U.S. Cl. CPC G06T 19/006; H04L 65/4015; G06T 3/40

(57) ABSTRACT

A system, device, and method for a real-time 3D augmented reality common operating picture (COP) enables at least one user to see all players in the environment using real-time data to populate movement and characteristics and interact with the environment to collaboratively see relevant information needed for their mission and purpose. Components include data processing system(s) 805; processor(s) 810; program code 815; computer readable storage medium 820; 3D display(s) 825; 3D environment model(s) 830; security module 835; time source 840; external source data 845; air platform(s) 850; land platform(s) 855; sea platform(s) 860; and user input 865. Operation involve environment identification 905; 3D model selection 1010; memory pool population 1015; 3D environment generation 1020; 3D environment display 1025; external data source selection 1030; external data source input 1035; platform display in 3D environment 1040; user input 1045; data panel display 1050; and system update 1055.

### FIELD OF THE DISCLOSURE

The application relates to a system, device, and method for a real-time 3D augmented reality common operating picture providing situational awareness for mission planning.

### BACKGROUND

In the fields of battlefield, anti-terrorism, peace-keeping, homeland security, and disaster relief operations there is a great need for automatic processing and dissemination of real-time 3D information providing comprehensive situational awareness for decision-making. The enormous volume of communications traffic absolutely requires intelligent selection, formatting, and presentation of only but all of the required data.

Currently, data to visualize activities in an environment is dispersed between many varied programs. Much data is lost among databases, and is impossible to see in a comprehensive manner. It is very difficult to be able to make decisions and plan, as the data is not visible in one location in a 3D format where moving factors can be seen in relation to each other. 2D displays for moving troops fail to provide 3D dimensions and proximity data. What is needed is the ability to see in a collaborative augmented manor a 3D battlespace with different players in the air, on land and in sea populated from streaming data to show movement and defining characteristics.

### SUMMARY

An embodiment provides a device for a secure, scalable, real-time 3D augmented reality (AR) common operating picture (COP) enabling a plurality of users to see entities in an environment using real-time data to populate movement and characteristics comprising a 3D AR COP system; at least one 3D display to display at least one 3D environment model for the plurality of users in two-way communication with the 3D AR COP system; at least one entity in two-way communication with the 3D AR COP system; a security module controlling the two-way communication between the at least one 3D display and the at least one entity; the scaling of the 3D AR COP system comprises a Memory Pool and real-time motion-prediction; real-time external source data comprising monitoring messaging bus packets by the 3D AR COP system; user input, wherein the user input selects data from the real-time external source data to display in relation to its source. In embodiments, the 3D display comprises a single shared 3D augmented reality holographic display for a plurality of users. In other embodiments, the 3D display comprises a 3D augmented reality display for each user. In subsequent embodiments the Memory Pool is prepopulated during startup and stored on the real-time 3D AR COP system, the Memory Pool subsequently used by the real-time 3D AR COP as needed, whereby the real-time 3D AR COP is scalable. For additional embodiments the 3D AR COP system comprises a hybrid-architecture comprising an object-oriented architecture encapsulating shared data and functionality among one common parent, which can then be inherited by several children which implement their own unique data and functionalities, reducing the need to duplicate code in multiple areas; and a component-based architecture, wherein different components are written up in scripts, giving a specific and separated functionality, each of the components is written generically whereby they can be reused among different objects. In another embodiment, a segmented-canvas of the 3D AR COP system comprises segmented canvases of an entire canvas whereby segmented canvases display information for each user enabling scaling of updating information by segmenting which parts of the entire canvas get updated. For a following embodiment, a shared-experience feature of the 3D AR COP system comprises a first headset designated as a master headset; one or more headsets controlled by the master headset; whereby the master headset controls obtaining and disseminating information from the messaging bus to populate shared-experience headset displays with relevant information, whereby each user participating in sharing can interact so that others will see reactions to each user's interaction. In subsequent embodiments the real-time motion-prediction comprises displaying predicted paths, based on historic data, when packets are lost, whereby asset movement is smoothly transitioned to an actual location when the packets are received. In additional embodiments the security module comprises corresponding a security level of each of the two-way communication with the 3D AR COP system and the at least one entity to a user-security level of each of the users for a security-selective display to the user.

Another embodiment provides a method for a secure, scalable, real-time 3D augmented reality common operating picture enabling at least one user to see entities in an environment using real-time data to populate movement and characteristics comprising identifying an environment; selecting a 3D model for the environment; populating a Memory Pool, whereby the real-time 3D augmented reality common operating picture is scalable; generating the 3D environment from the 3D model; displaying the 3D environment; selecting a plurality of external data sources; inputting the external data sources; filtering display information in a security module; displaying at least one moving object asset from the external data sources in the 3D environment; accepting input from at least one user; displaying a data panel representing the characteristics in response to the input; and updating the real-time data comprising monitoring messaging bus packets. Included embodiments comprise test scenario capabilities whereby equipment is evaluated; mission planning capabilities wherein the real-time data is simulated; and live mission capabilities wherein active components are determined by actual real-time data, and assets are directed through bidirectional communications with them. In yet further embodiments, mission planning capabilities comprise displaying and comparing different routes. Related embodiments display locations of interest, wherein data of the locations is displayed in both Latitude/Longitude (Lat/Long) and Military Grid Reference System (MGRS); and wherein the external source data comprises at least one of air platform real-time data; land platform real-time data; and sea platform real-time data. Further embodiments display locations of interest comprising past IED attacks, known hostile regions, air support locations, and route travel repetition; and displaying lethality of weapons from moving components, the lethality comprising projected air strikes from a moving aircraft and artillery from troops. Ensuing embodiments compare and contrast a time range needed to travel a route, projected danger of each route, and obstacles expected along the route. Yet further embodiments comprise a radar display for a minimized view of moving components. More embodiments identify which assets are involved in the same mission; and the data panel display comprises fuel levels for tanks and aircraft, and food rations for ground troops. Continued embodiments include machine learning whereby a user is allowed to only see what information is relevant to that individual; and displaying a text breakdown of battlefield relevance of entities that are currently in a space, selected from the group consisting of friendly, enemy, ally, and avoid; wherein a Hidden Markov Model learns and adapts based on identifiable information on the user. For additional embodiments, the security module comprises display control comprising a role of the user, wherein the role comprises a security clearance level of each user; filtering of the at least one 3D environment model and the real-time external source data according to a security level assigned to each, whereby each of the users is presented only the model and the source data at or below the security clearance level of each user; and for a shared-display, only the model and the source data at or below the security clearance level of the user having a lowest security level is displayed.

A yet further embodiment provides a system for a secure, scalable, real-time 3D augmented reality (AR) common operating picture (COP) enabling a plurality of users to see entities in an environment using real-time data to populate movement and characteristics comprising at least one 3D augmented reality device; at least one processor; in the at least one processor: organizing folders outputting JSON format data; populating a memory pool, whereby the real-time 3D augmented reality common operating picture is scalable; the folders comprising service engines folder, holograms folder, and 2525 symbol library folder, wherein the folders are expandable by adding new source data pipes and service engines; wherein input to the folders comprises external source data pipes providing input to at least one Combat ID Server which provides output to a prestrike IFF; wherein output from the folders comprises 3D-GEO, ADS-B, FBCB-2, TADIL-J, C-RAM, and weather; wherein each of the ADS-B, FBCB-2, TADIL-J, C-RAM, and weather comprises JSON output; wherein the 3D-GEO output comprises at least one geographic region; wherein output from the folders comprises JSON format data; wherein a user selects appropriate service engines in a resident cop application; and in a topology no data is retained in the augmented reality device, only a core COP application remains resident, all working data is pulled from the combat ID (CID) server when needed by selected service engines; and an auto zero is executed at power off.

### BRIEF DESCRIPTION OF THE DRAWINGS

FIG. 1 depicts a holographic 3D Augmented Reality (AR) Common Operating Picture (COP) single display system configured in accordance with an embodiment.

FIG. 2 depicts a holographic 3D Augmented Reality (AR) Common Operating Picture (COP) single user display system configured in accordance with an embodiment.

FIG. 3 is a 3D Augmented Reality (AR) Common Operating Picture (COP) system real time data component configured in accordance with an embodiment.

FIG. 4 is a 3D Augmented Reality (AR) Common Operating Picture (COP) system live aircraft 3D display depiction configured in accordance with an embodiment.

FIG. 5 is a 3D Augmented Reality (AR) Common Operating Picture (COP) system live land-air-sea 3D display depiction configured in accordance with an embodiment.

FIG. 6A is a 3D Augmented Reality (AR) Common Operating Picture (COP) system components depiction configured in accordance with an embodiment.

FIG. 6B is a 3D Augmented Reality (AR) Common Operating Picture (COP) system components depiction configured in accordance with an embodiment.

FIG. 7 is a 3D Augmented Reality (AR) Common Operating Picture (COP) system architecture depiction configured in accordance with an embodiment.

FIG. 8 is a 3D Augmented Reality (AR) Common Operating Picture (COP) system components block diagram configured in accordance with an embodiment.

FIG. 9 is a 3D AR COP system security module interface block diagram embodiment.

FIG. 10 is a flow chart depicting the steps of a method for a 3D Augmented Reality (AR) Common Operating Picture (COP) system configured in accordance with an embodiment.

FIG. 11 depicts a Memory Pool for a 3D AR COP system embodiment.

FIG. 12 depicts a hybrid-architecture for a 3D AR COP system embodiment.

FIG. 13 depicts a segmented-canvas for a 3D AR COP system embodiment.

FIG. 14 depicts shared-experience features for a 3D AR COP system embodiment.

FIG. 15 depicts motion-prediction for a 3D AR COP system embodiment.

These and other features of the present embodiments will be understood better by reading the following detailed description, taken together with the figures herein described. The accompanying drawings are not intended to be drawn to scale. For purposes of clarity, not every component may be labeled in every drawing.

### DETAILED DESCRIPTION

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes, and not to limit in any way the scope of the inventive subject matter. The invention is susceptible of many embodiments. What follows is illustrative, but not exhaustive, of the scope of the invention.

TERMINOLOGY—The following identifies some of the terms and acronyms related to embodiments. 4D: three spatial dimensions plus changes over time; AR: Augmented Reality; ASOC: Air Support Operations Center; BDE: BrigaDE; BTID: Battlefield Target Identification Device; CABLE: Communications Air-Borne Layer Expansion; CID: Combat ID; COP: Common Operating Picture; DDL: Data Definition Language; DIS: Defense Information System; EFT: Emulated Force Tracking; FAC: Forward Air Controller; FBCB2: Force XXI Battle Command Brigade and Below; FSO: Fire Support Officer; GW: GateWay; HTTP: HyperText Transfer Protocol; IFF: Identify Friend or Foe; INC: Internet Controller; IP1: data transfer push profile; ISAF: International Security Assistance Force (of NATO); JFIIT: Joint Fires Integration and Interoperability Team; JRE: Joint Range Extension; JSON: JavaScript Object Notation; MGRS: Military Grid Reference System; NATO: North Atlantic Treaty Organization; NAV: Navy; NFFI: NATO Friendly Force Information; NORTAC: Norway Tactical C2 system; NTP: Network Time Protocol; PLI: Position Location Information; QNT: QUINT Networking Technology; RAY DDL: RAY Data Definition Language; RBCI: Radio Based Combat Identification; SAIL: Sensor Abstraction and Integration Layer; SINCGARS: Single Channel Ground and Airborne Radio System; SIP3: System Improvement Program; SRW: Soldier Radio Waveform; TACAIR: Tactical Air Support; TACP: Air Force Tactical Air Control Party; TADIL: Tactical Digital Information Link; TCDL: Tactical Common Data Link (secure); TDL: Tactical Data Link (secure and unsecure); VMF K05.1: Variable Message Format.

Embodiments of the augmented reality application allow a user to see all players and assets in the battlefield using real-time data to populate movement and characteristics. In one embodiment a head(s)-up display shows a summary of information that is seen and contains the interaction guide. In contrast, a radar display provides a minimized view of the moving components. Each moving component also contains a panel which displays data pertaining to itself (capabilities. descriptions, —etc).

Embodiments provide a 3D augmented display of a region with streaming real-time data prompting movement to platforms. In embodiments, these platforms can be interacted with using either voice commands or a tapping gesture to be able to see more information relating to that specific vehicle on a data panel, such as aircraft type, callsign, latitude/longitude, speed, altitude, etc. This data panel can be expanded for better visibility, or made to disappear to eliminate obstruction of view to other components. A head(s)-up display provides a summary of the moving components displayed in the region at one time. In text, embodiments give a breakdown of the battlefield relevance of the entities that are currently in the space, such as friendly, enemy, ally, and avoid. A visual description minimizes the scene to a 2D head-up display, which can also be converted to a 3D minimized representation of the moving components.

Embodiments provide modes that can allow the user to only see what information is relevant to that individual; embodiments use machine learning to deliver this in a dynamic way, so the user is not overcrowded with irrelevant information. Embodiments provide mission planning capabilities, including displaying and comparing different routes. While comparing, locations of interest can be displayed. Nonlimiting examples of locations of interest comprise past IED attacks, known hostile regions, available air support locations, and how often a route is travelled. Embodiments enable comparing and contrasting a time range needed to travel a route, the projected danger of each route, and what obstacles may be encountered along the way. In an application of evaluating a mission in real time, the capabilities available to assets in a region are displayed so as to be able to direct the capabilities and assets in support of the mission. Nonlimiting examples of display information include fuel levels for tanks and planes and food rations for troops on the ground. Embodiments present communications links between different entities/assets and display which entities/assets are involved in the same mission. Embodiments can be used by an individual, or by multiple users in a collaborative manner. Embodiments can also be used in a commercial setting for air traffic control, ship monitoring, or vehicle traffic management.

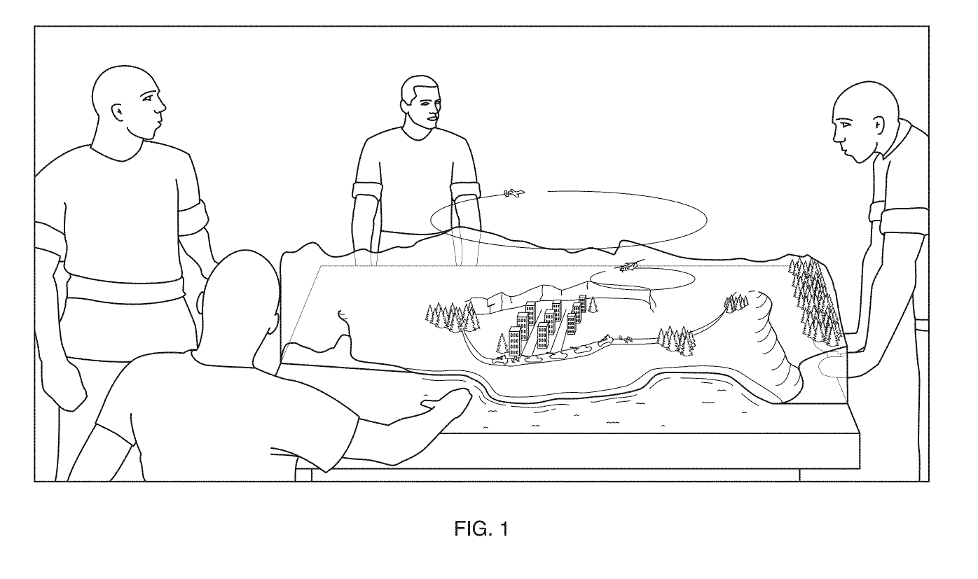

FIG. 1 depicts live holographic 3D Augmented Reality (AR) Common Operating Picture (COP) single display system embodiment 100. 3D terrain is shown with assets superimposed based on real-time location. Multiple users share the Common Operating Picture, updated in real-time. In embodiments, superimposed assets comprise individuals, air land and sea platforms. Data panels are available by default or upon command to augment the display of reality represented by the system. In embodiments, data panels are presented based on voice and or gesture commands. In embodiments, real-time updates are provided by streaming data. In embodiments, real-time updates are provided by streaming data including data from sensors and the assets such as aircraft, land vehicles, and troops. The location, direction, speed of travel along with environmental and terrain data for the paths to enable more accurate projections and difficulties. The data can include items such as the number of persons, casualties, and capabilities. The capabilities, for example, may include the number and type of munitions that can enable refinement of the targets and optimize the combined capabilities for a successful mission. Views can depict the region with different angle perspectives and can zoom in on any specific area. The region images can be captured from multiple sensors and stitched together to provide a more accurate 3D model. For example, the sensors from a drone and land vehicle can be combined so that the region image accuracy is enhanced for the real-time 3D region display. Embodiments are dynamically updated to reflect real time images.

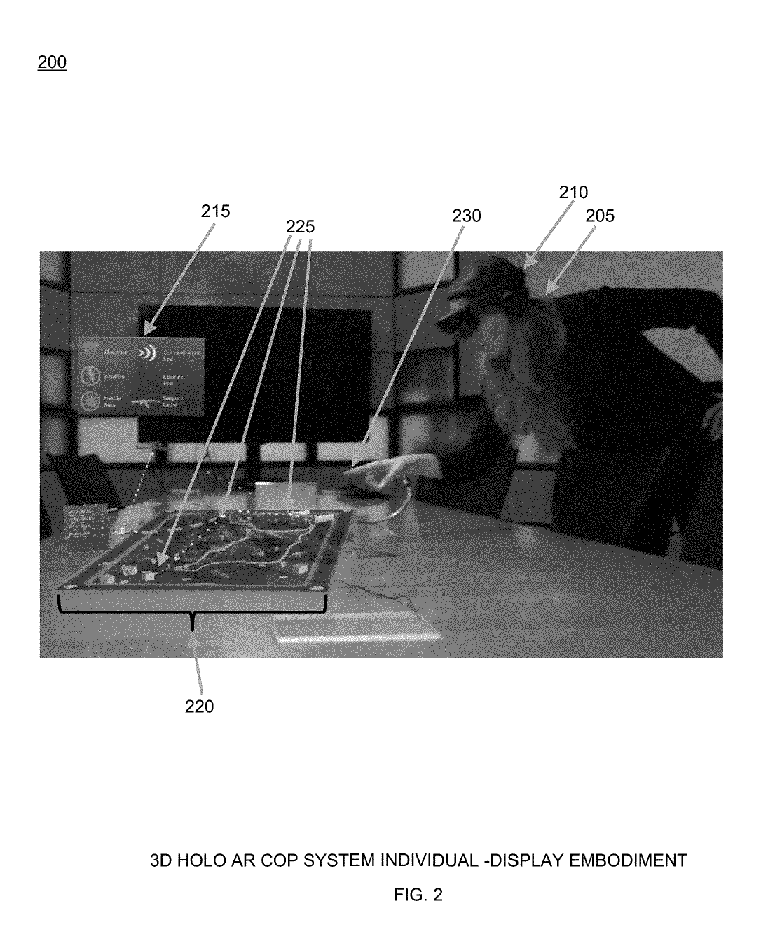

FIG. 2 depicts live holographic 3D Augmented Reality (AR) Common Operating Picture (COP) single user display system embodiment 200. User 205 wears holographic goggles 210, helmet, or other similar headgear that enables the 3D holographic imagery of the site and the assets, including the ability to obtain detailed information via data panels 215. 3D terrain 220 is shown with assets 225 superimposed based on real-time location. Multiple individual users 205 (one shown) share the Common Operating Picture, updated in real-time. In embodiments, superimposed assets comprise individuals, air land and sea platforms. Data panels 215 are available by default or upon command to augment the display of reality represented by the system. In embodiments, data panels 215 are presented based on voice and or gesture 230 commands.

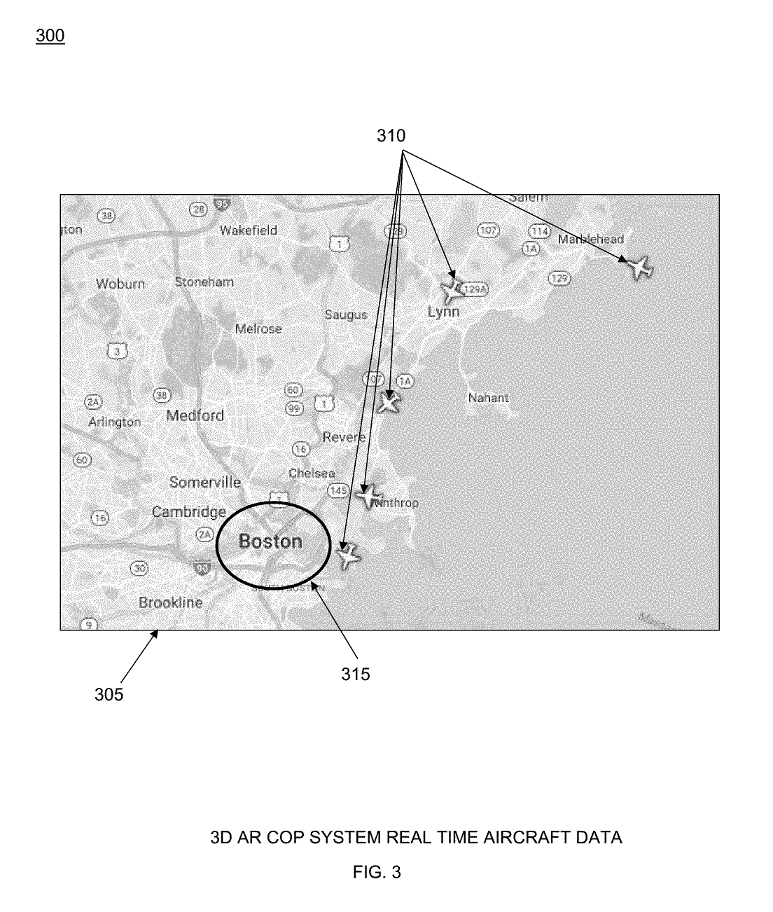

FIG. 3 illustrates a 3D AR COP system real time data component embodiment 300. 2D Map 305 provides context for live real-time data for aircraft 310 (which include altitude) to render in 3D along with the 3D environment model. 2D area displayed is for Boston 315 as in depictions of 3D city model 200. Embodiments stream-in real-time data based off aircraft communications. The aircraft communications feed the system with information on various aircraft locations and data. Embodiments then convert that data to meet the dimensions of the 3D augmented reality space, and prompt direction and speed of the movement. Embodiments improve performance by identifying the intake of less reliable of data. Based on historic data, predicted paths are displayed when packets are lost, and movement is smoothly transitioned to actual location when packets are received. Embodiments can be configured to either run in real time or play back recorded flight data. In one example, a user can zoom in and/or obtain detailed information about any specific aircraft, including IFF data. The 3D AR provides the user the important altitude element for aircraft such that the various aircraft can be deployed and tracked in x, y and z axis. Embodiments proportionally scale the altitude to the real world, so proportions are correct when observing planes' movement and relationship to the 3D model. The Radar view does not provide altitude information; it pointedly converts the viewing to a 2D view, so you can conceptually see the planes in a different orientation that is not as easily visible when looking at the entire scope.

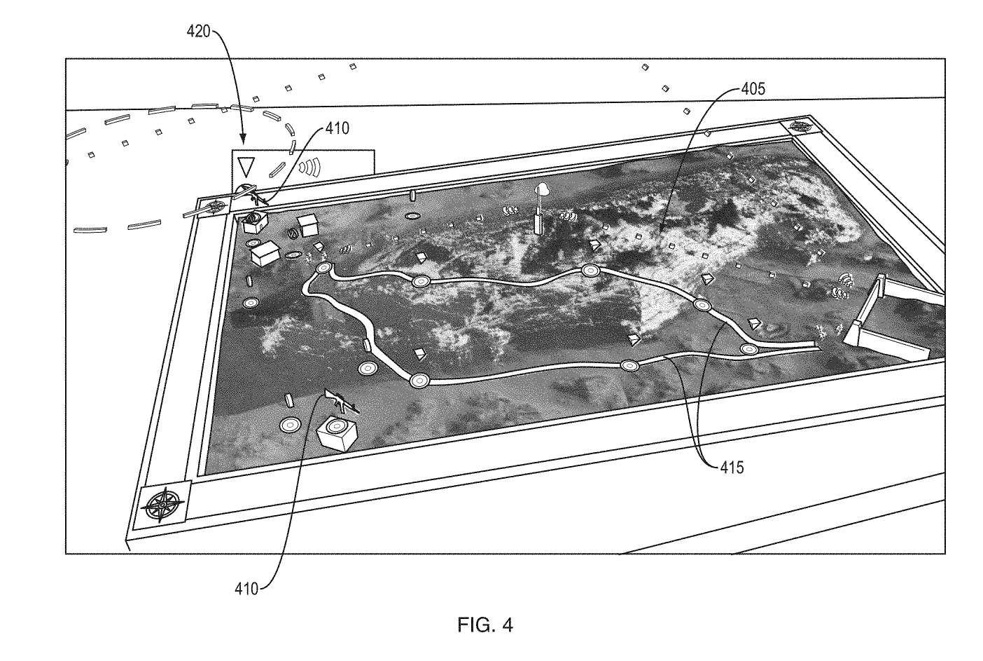

FIG. 4 illustrates a 3D AR COP system live 3D display depiction embodiment 400 with a 3D model of terrain 405, aircraft 410, and ground based assets 415 (e.g., buildings, weapons, troops, land vehicles . . . ), sensors (e.g., radar towers, cameras . . . ). Aircraft with flight paths 410 are displayed in real-time locations above land/sea. Here, a dashed circle depicts the loiter path of an aircraft over the terrain. In a further embodiment the sea based assets such as ships, submarines and unmanned submersible vehicles are depicted in a 3D display. Ground paths 420 are displayed along the terrain. Data panel 425 presents various forms of information such as date/time information and options for further details.

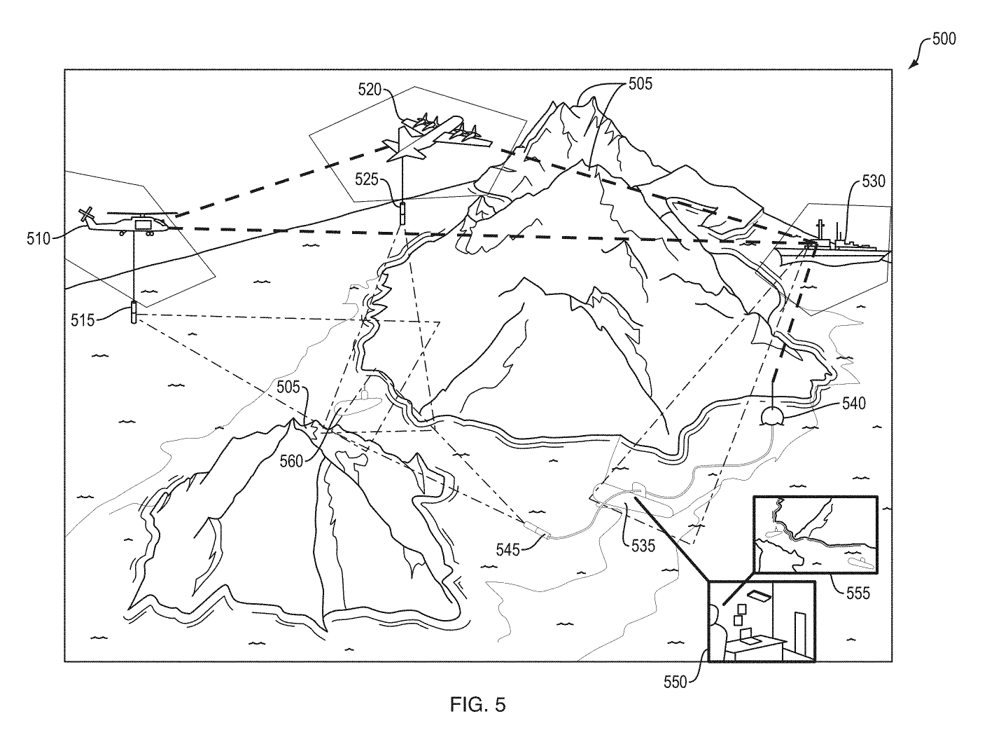

FIG. 5 illustrates a 3D AR COP system live land-air-sea 3D display depiction embodiment 500. Islands 505 are depicted protruding from surrounding sea. Helicopter 510 is depicted at its real-time location, deploying transponder 515. Similarly, aircraft 520 is depicted at its real-time location, deploying transponder 525. Ship 530 is depicted at its real-time location. Submarine 535 is depicted at its real-time location, deploying assets communications buoy 540 and sensor 545. Submarine 535 receives data 550 and 555 from sensor 545 asset and communicates over buoy 540 asset. Data 550, 555 is provided to 3D AR COP for display in real-time. In embodiments, data 550, 555 comprises sonar and composite imagery. In embodiments, surveillance assets produce data including real-time live location and imagery for submarine target 560. In one embodiment the display can isolate and filter to only what is of current interest and appropriate classification level for the user.

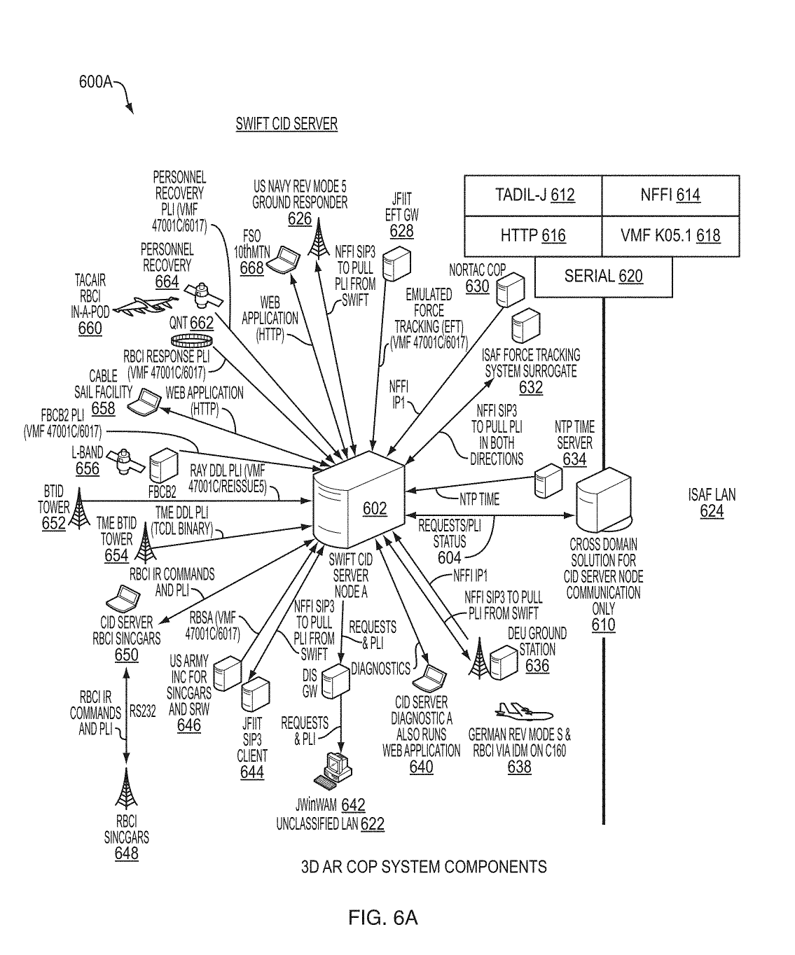

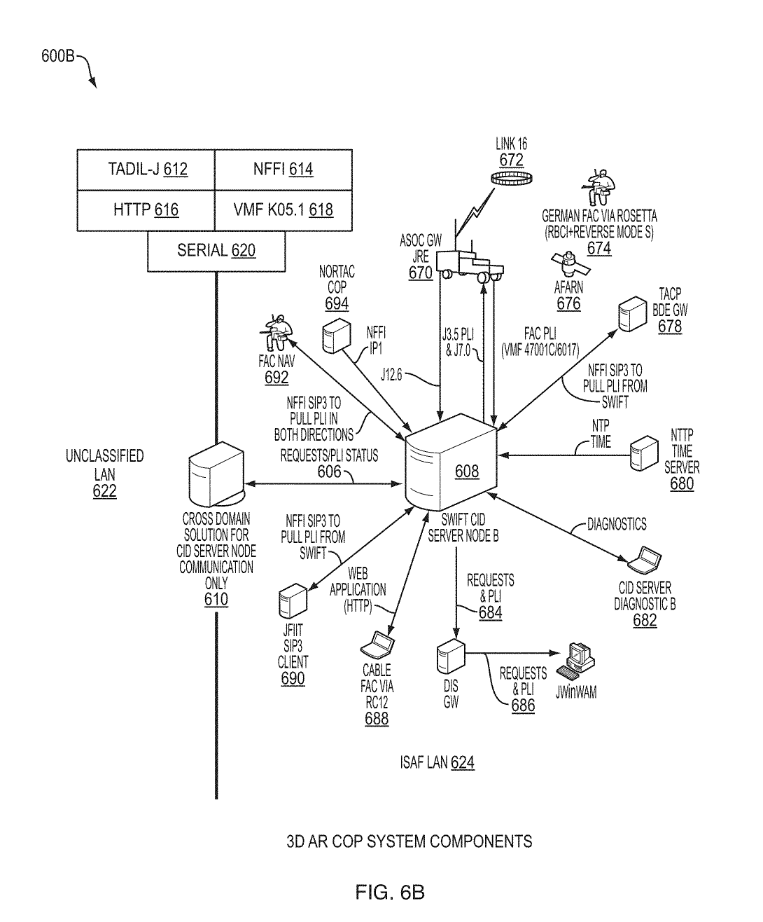

FIG. 6A is a 3D AR COP system unclassified LAN components embodiment depiction 600A. (Please see Terminology paragraph for acronym definitions.) SWIFT CID Server Node A 602 communicates requests/PLI status 604, with SWIFT CID Server Node B 608 via communication-only Cross Domain CID Server Node 610. In embodiments, communications via Cross Domain CID Server Node 610 comprise TADIL-J 612, NFFI 614, HTTP 616, VMF K05.1 618, and serial 620 protocols. In embodiments, SWIFT CID Server Node A 602 comprises an unclassified LAN 622, and SWIFT CID Server Node B 604 comprises an ISAF LAN 624.

SWIFT CID Server Node A 602 communicates with a great number of sources which provides importantly significant real-time access to data as required to support the live 3D AR COP system. In embodiments, these sources comprise NFFI SIP3 to pull PLI from SWIFT for a US Navy Rev Mode 5 ground responder 626; EFT (VMF 47001C/6017) to JFIT EFT GW 628; NFFI SDIP3 to pull PLI in both directions with NFFI IP1 from NORTAC COP 630 and ISAF FORCE TRACKING SYSTEM SURROGATE 632; NTP Time comes from NTP Time Server 634; NFFI SIP3 to pull PLI from SWIFT and NFFI IP1 from DEU Ground Station 636 and German Rev Mode S & RBCI via IDM on C160 638; diagnostics proceed to CID Server Diagnostic A 640 (also runs web application); requests & PLI proceed to DIS GW then requests & PLI to JWinWAM 642; NFFI SIP3 to pull PLI from SWIFT for JFIIT SIP3 Client 644; RB SA (VMF 47001C/6017) is received from US Army INC for SINCGARS and SRW 646; RCBI IR Commands and PLI are exchanged with CID Server RBCI SINCGARS 648, which communicates with RBCI SINCGARS 650 by RBCI IR Commands and PLI by RS232; TME DDL PLI (TCDL binary) and RAY DDL PLI (VMF 47001C/Reissue5) are received from BTID Tower 652 and TME BTID Tower 654; FBCB2 PLI (VMF 47001C/6017) is received from L-Band satellite and FBCB2 656; Web Application (HTTP) is exchanged with CABLE SAIL facility 658; RCBI response PLI (VMF 47001C/6017) is received from TACAIR RCBI in-a-pod 660 and QNT 662; Personnel Recovery PLI (VMF 47001C/6017) is received from Personnel Recovery satellite 664; Web Application (HTTP) is sent to FSO 10th MTN 668, for example. While not exhaustive, this listing demonstrates scalability with many entities/assets.

FIG. 6B is a 3D AR COP system ISAF LAN components embodiment depiction 600B. (Please see Terminology paragraph for acronym definitions.) SWIFT CID Server Node B 608 communicates requests/PLI status with SWIFT CID Server Node A 602 in unclassified LAN 622 via communication-only Cross Domain CID Server Node 610. In embodiments, communications via Cross Domain CID Server Node 610 comprise TADIL-J 612, NFFI 614, HTTP 616, VMF K05.1 618, and serial 620 protocols. In embodiments, SWIFT CID Server Node A 602 comprises an unclassified LAN 622, and SWIFT CID Server Node B 604 comprises an ISAF LAN 624.

SWIFT CID Server Node B 608 also communicates with a great number of sources which provides importantly significant real-time access to data as required to support the live 3D AR COP system. In embodiments, these sources comprise J12.6 from, J3.5 PLI & J7.0 to, and FAC PLI (VMF 47001C/6017) from ASOC GW JRE 670 and Link 672 to/from ASOC GW JRE 670; NFFI SIP3 to pull PLI from SWIFT with German VAC via Rosetta (RCBI+Reverse Mode S) 674, AFARN 676, and TACP BDE GW 678; NTP Time from NTP Time Server 680; Diagnostics with CID Server Diagnostic B 682; Requests & PLI to DIS GW 684 and Requests & PLI from DIS GW to JWinWAM 686; Web Application (HTTP) with CABLE FAC Via RC12 688; NFFI SIP3 to pull PLI from SWIFT with JFIIT SIP3 Client 690; NFFI SIP3 to pull PLI in both directions with FAC NAV 692; and NFFI IP1 from NORTAC COP 694. Again, while not exhaustive, this listing demonstrates scalability with many entities/assets.

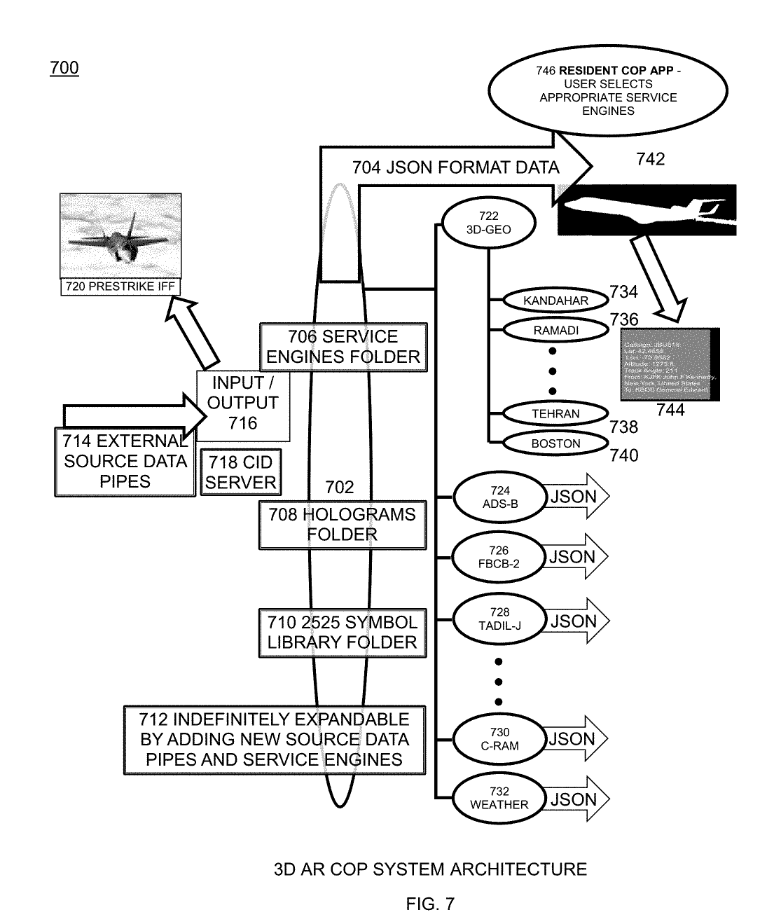

FIG. 7 is a 3D AR COP system architecture depiction 700 according to one embodiment. Processing architecture organizes folders 702, outputting format data 704 such as JSON format data. In one example, folders 702 comprise Service Engines Folder 706, Holograms Folder 708, and 2525 Symbol Library Folder, where the folders 702 are expandable by adding new source data pipes and service engines. The format data 704 is an input to a particular asset 742 such as a plane and the format allows the asset to retrieve and process the data.

In one example, input to folders 702 comprises External Source Data Pipes 714; providing input to 716 CID Server 718 which provides output to a Prestrike IFF 720. Output from Folders 702 comprises 3D-GEO 722, ADS-B 724, FBCB-2 726, TADIL-J 728, C-RAM 730, and Weather 732 which may be supplemented by other outputs. Each of ADS-B 724, FBCB-2 726, TADIL-J 728, C-RAM 730, and Weather 732 comprises JSON output. 3D-GEO 722 output comprises non-limiting regions such as Kandahar 734, Ramadi 736, Tehran 738, and Boston 740. JSON Format Data 704 from Folders 702 is provided for an asset 742, with relevant data panel 744. In the Resident COP Application the user selects appropriate Service Engines 746.

In one embodiment, a user or users interacts with the system to trigger animations on the Head(s) up Display (HUD), which provide all available voice commands. The trigger in one example is via gestures. The HUD can also be minimized when not needed. In embodiments, voice commands comprise: i. Making all of the individual plane data panels visible and invisible; ii. Displaying and hiding an MGRS grid overlay to give MGRS location data as well as lat/long; iii. Displaying and hiding a trajectory from the planes over a city for strike zone if that plane were to carry out an air strike, as well as indicating which locations to avoid striking near to avoid striking friendly forces; and iv. Prompting and stopping audio streaming for communication sources or air traffic control. When recorded data is chosen, embodiments play back data that was previously recorded.

In topology embodiments no data is retained in the augmented reality device (for example, HoloLens), only the core COP application remains resident. For embodiments, all working data is pulled from the CID Server when needed by the selected Service Engines; Auto Zero at power off. JSON data is streamed into the system, connected to each of the vehicle objects, which are created using a Memory Pool. This significantly and importantly increases the efficiency in computation and memory by being able to reuse predefined 3D models. The data is then used through the system's computation to prompt movement as well as to be able to display the data in individual panels.

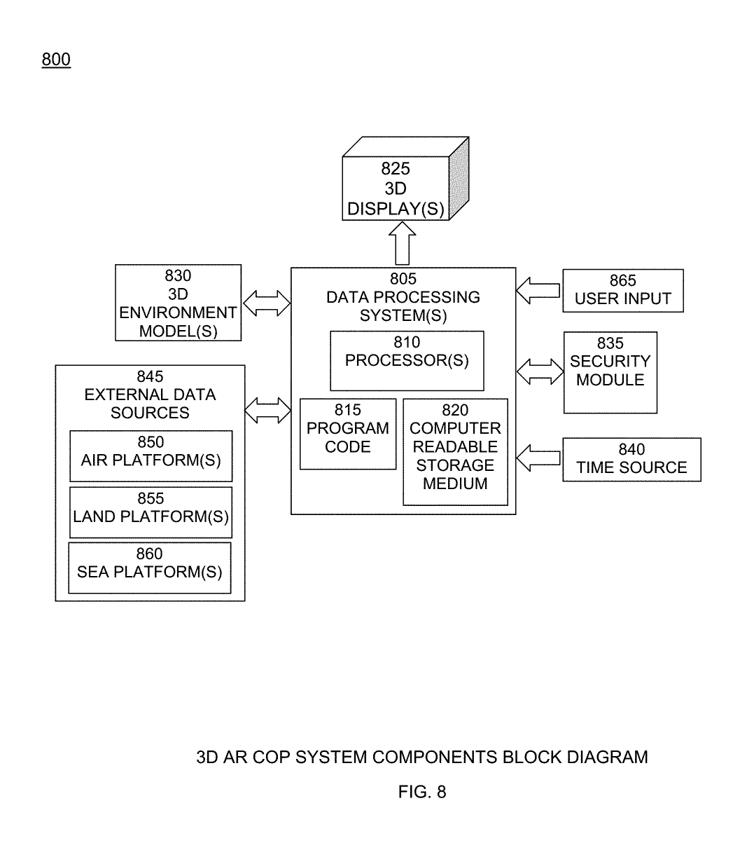

FIG. 8 is a 3D AR COP system components block diagram embodiment 800. Embodiments comprise Data Processing System(s) 805; Processor(s) 810; Program Code 815; Computer Readable Storage Medium 820; 3D Display 825; 3D Environment Model(s) 830; Security Module 835; Time Source 840; External Source Data 845; Air Platform(s) 850; Land Platform(s) 855; Sea Platform(s) 860; and User Input 865.

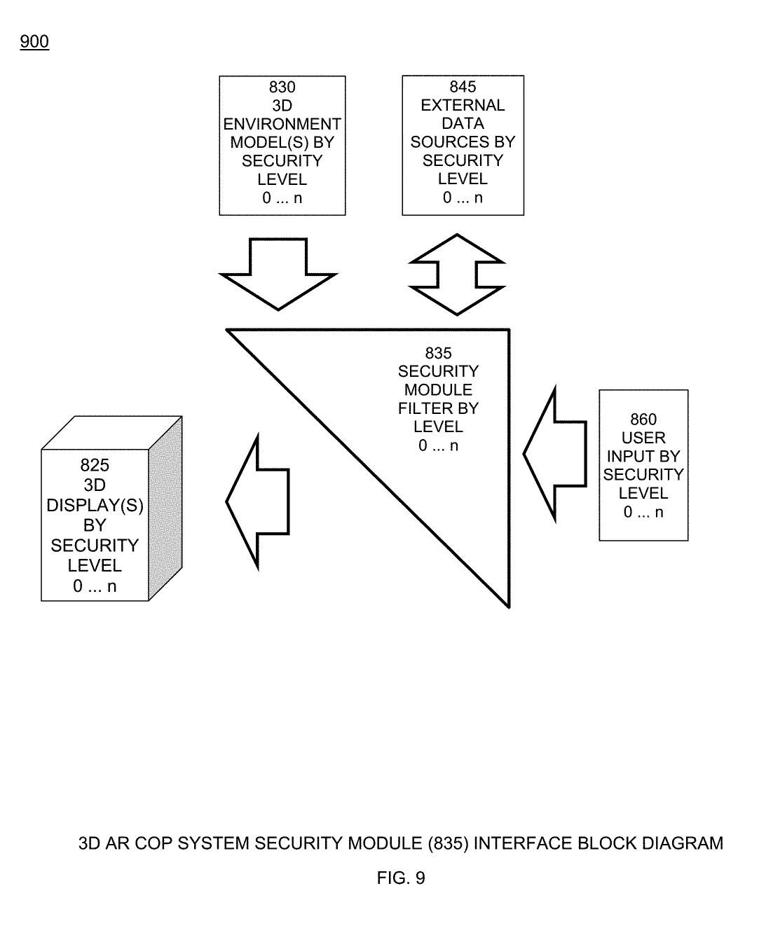

FIG. 9 is a 3D AR COP system security module (835) interface block diagram embodiment 900. Embodiments comprise security module 835 that receives security-level designated input from each of 3D Environment Model(s) 830, External Source Data 845, and User Input 865. Security module 835 filters communications by security level 0 to n whereby each user only receives results commensurate with each user's security level. Embodiments include audio filtering by security level. In embodiments, data displayed is filtered based on security clearance. For embodiments, this may mean data shown on panels, and vehicles would be nonexistent if their location is classified at a certain level, and specific target mission information may be either available or not or filtered. Note that the value of “n” may be different for users, environments, and data sources; in other words there will likely be different numbers of environments and data communications at various security levels versus users and their security levels.

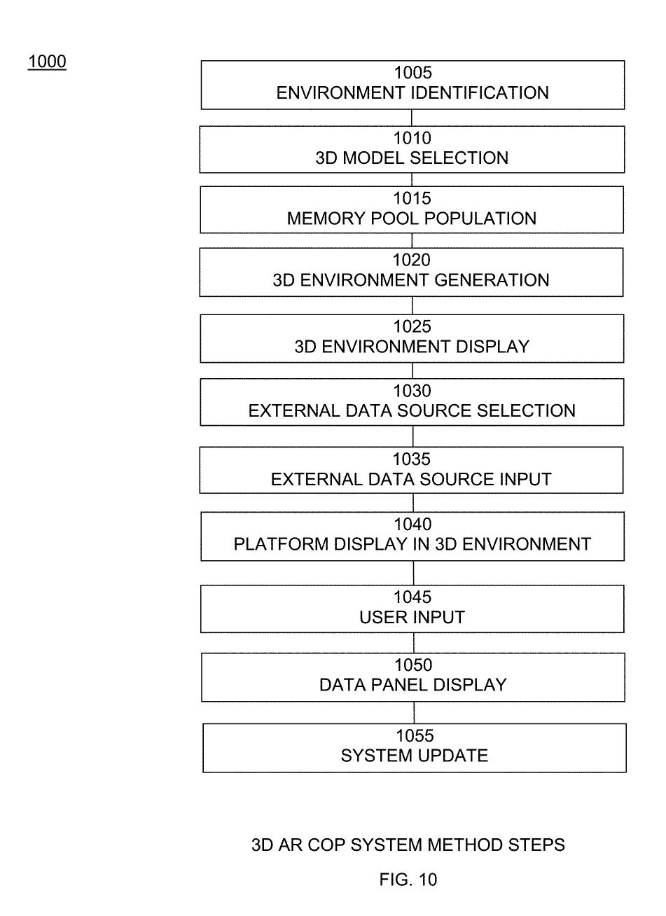

FIG. 10 is a flowchart 1000 depicting the steps of a method for a 3D AR COP system embodiment. In embodiments, steps of the method comprise: Environment Identification 1005; 3D Model Selection 1010; Memory Pool Population, 1015; 3D Environment Generation 1020; 3D Environment Display 1025; External Data Source Selection 1030; External Data Source Input 1035; Platform Display in 3D Environment 1040; User Input 1045; Data Panel Display 1050; System Update 1055. For embodiments, in addition to the Data Panel Display are an MGRS Grid overlay display, a streaming audio indication display, and an air strike view with avoid areas highlighted. In embodiments,

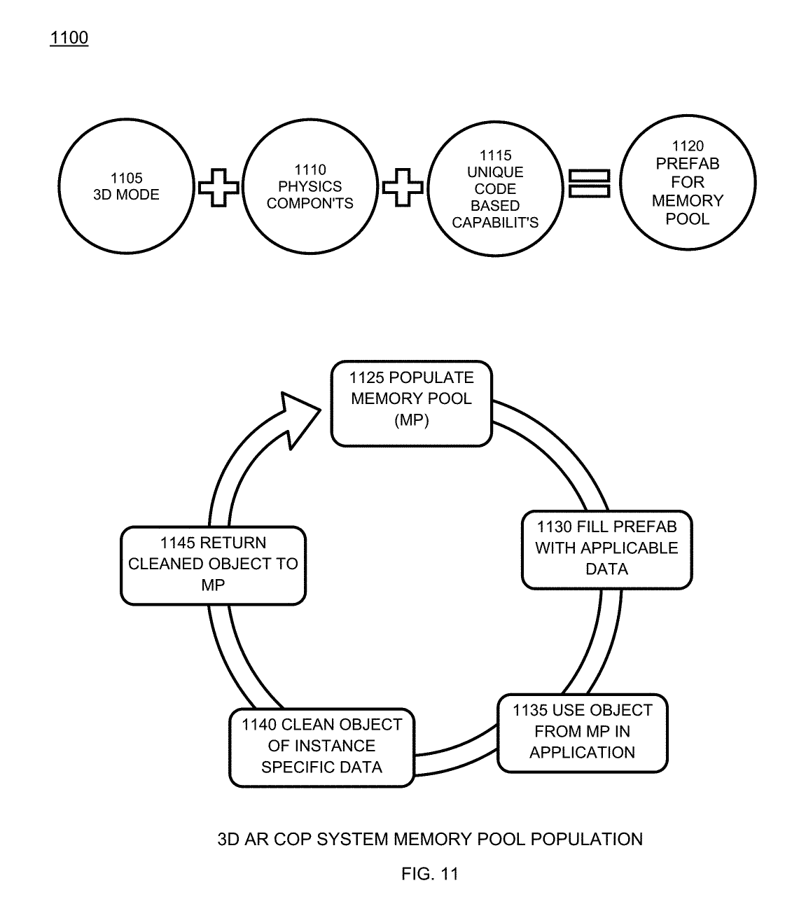

FIG. 11 depicts a Memory Pool cycle 1100 for a 3D AR COP system embodiment. Memory Pool begins by combining 3D Mode 1105 with Physics Components 1110 and Unique Code Based Capabilities 1115 to create the Prefab 1120 for Memory Pool. Memory Pool Population 1125 begins by Filling Prefab With Applicable Data 1130. An Object from the Memory Pool is Used in Application 1135. The Object is Cleaned of Instance Specific Data 1140. Finally, the Cleaned Object is Returned to Memory Pool 1145. In embodiments, Memory Pool Population 1015 comprises, at startup, a display loaded based off the region of interest. During this display loading process, the Memory Pool is populated with all objects that may be wanted during use of the application, which significantly and importantly speeds up the runtime process through reuse of objects. The system then queries and receives data that prompts creation of objects from the Memory Pool and starts their movement. At this point, the user is able to interact as they'd like, displaying more information on the moving components, seeing potential air strike zones, hearing communications, etc. Memory Pool population is not environment dependent. Embodiments use the Memory Pool structure within the zenject library, specifically making one for each aircraft (or asset) model. For example, the Memory Pool is prepopulated with the number of aircraft anticipated on display at one time. Expanding this structure, this is used for any model to be used within the program (tanks, ships, soldiers, marines, dogs, bombs, etc.). This is a structure that allows constructing 3D models on start-up, which can be reused as you need them, avoiding the construction and destruction of 3D models with their configured attributes every time it is needed. This significantly and importantly improves efficiency during runtime, supporting scalability. Embodiments use Prefab Structures, which allow creating the ‘model’ of a constructed object with preconfigured functionality so that Prefab can be easily reused during runtime.

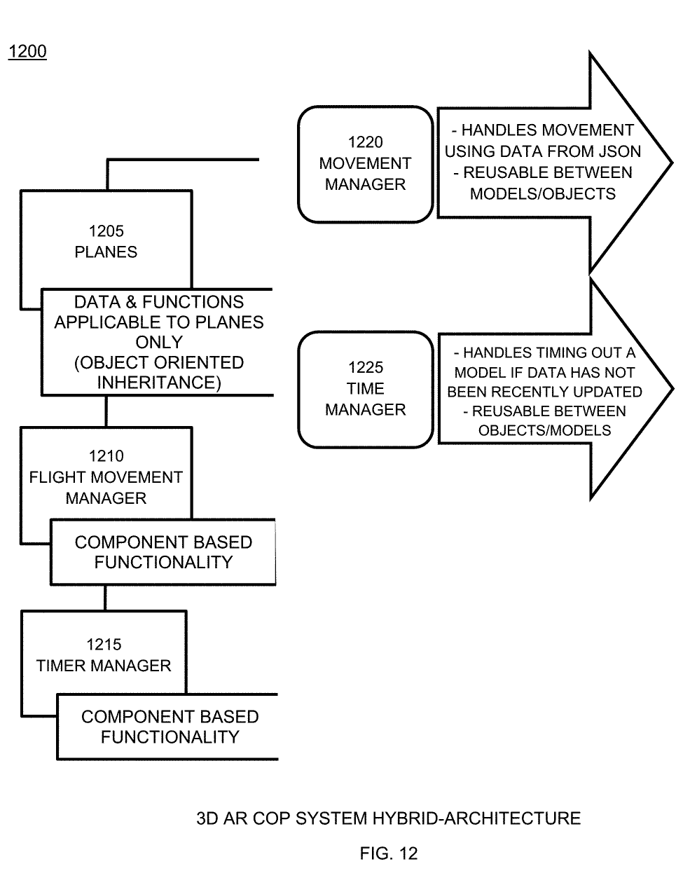

FIG. 12 depicts a hybrid-architecture 1200 for a 3D AR COP system embodiment. Components comprise Planes 1205 with data and functions applicable only to planes through object-oriented inheritance; Flight Movement Manager 1210 using component based functionality; and Time Manager 1215 also using component based functionality. Movement Manager 1220 handles movement using data from JSON that is reusable between models/objects. Time Manager 1225 Handles timing out a model if data has not been recently updated and is reusable between objects/models. In embodiments, the structure of the program is architected using a hybrid object oriented and component-based architecture that uses dependency injection (DI) to bypass passing relevant variables through layers of classes, which helps make more succinct code. Object Oriented architecture allows encapsulating shared data and functionality among one common parent, which can then be inherited by several children which implement their own unique data and functionalities, reducing the need to duplicate code in multiple areas. Different components are written up in scripts, giving a specific and separated functionality. Each of these components is written in a generic way so they can be reused among different objects. As identified above, Movement Manager & Time Manager are Component-based reusable components. In embodiments, a Vehicle object is an Object Oriented Parent with three Object Oriented Inherited Children (Planes, HMMWVs, and Ships). Each of these inherited Children hold reusable functionality such as the Movement Manager and Time Manager, though other reusable components can be used as well, as shown in the diagram.

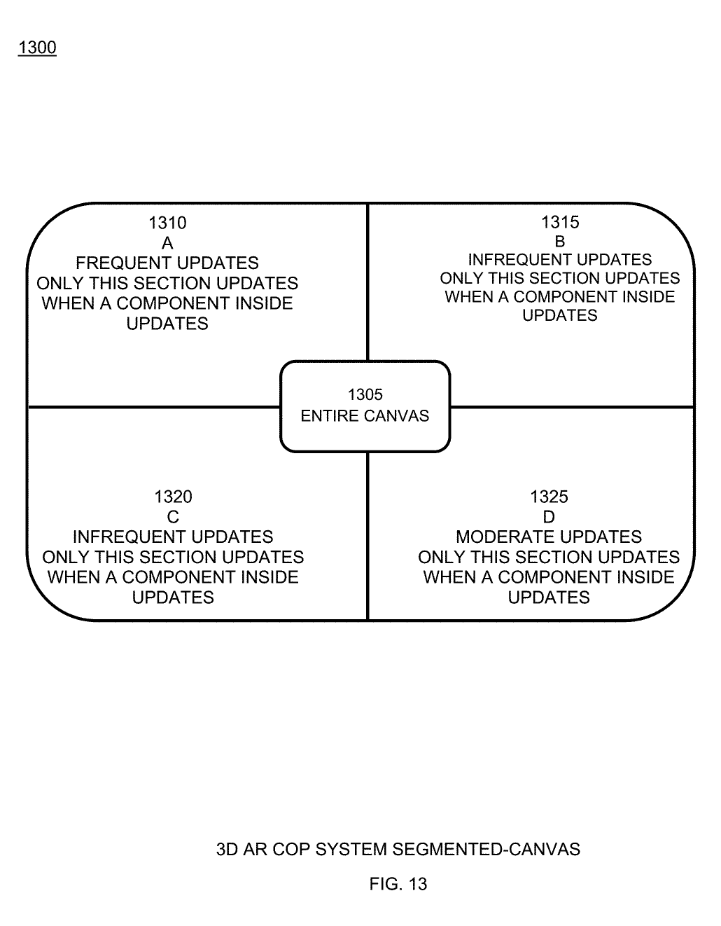

FIG. 13 depicts a segmented-canvas 1300 for a 3D AR COP system embodiment. Canvases are put together so that display information for the user is presented in a way that helps optimize updating the information by segmenting which parts of the canvas gets updated. If the entire canvas 1305 were only created using one canvas component, the entire canvas would update every single time any component within the canvas was updated (text, image, etc.). By segmenting each canvas section into different child canvases, updates are optimized by only making necessary components update in a frequently updating terrain. For example, the diagram shows child canvases A 1310, B 1315, C 1320, and D 1325 as components of a parent canvas. Because it is known that A 1310 has frequent updates, by segmenting it off, it will not prompt B 1315, C 1320, or D 1325 to update when it has to be updated, which reduces computation. D 1325 shows that it has moderate updates as well, so by segmenting this off, this will not prompt updates in A 1310, B 1315, or C 1320 when it has to be updated. Another attribute considered is the complexity of what has to be updated. For example, text components on the Heads Up Display are one segmented child canvas. The miniature map is another canvas segment. By segmenting this off, the map does not have to be redrawn twice for both components, as the JSON would potentially prompt a change in plane location and totaling data, but instead, they can both be redrawn separately to reflect the changes, reducing computation.

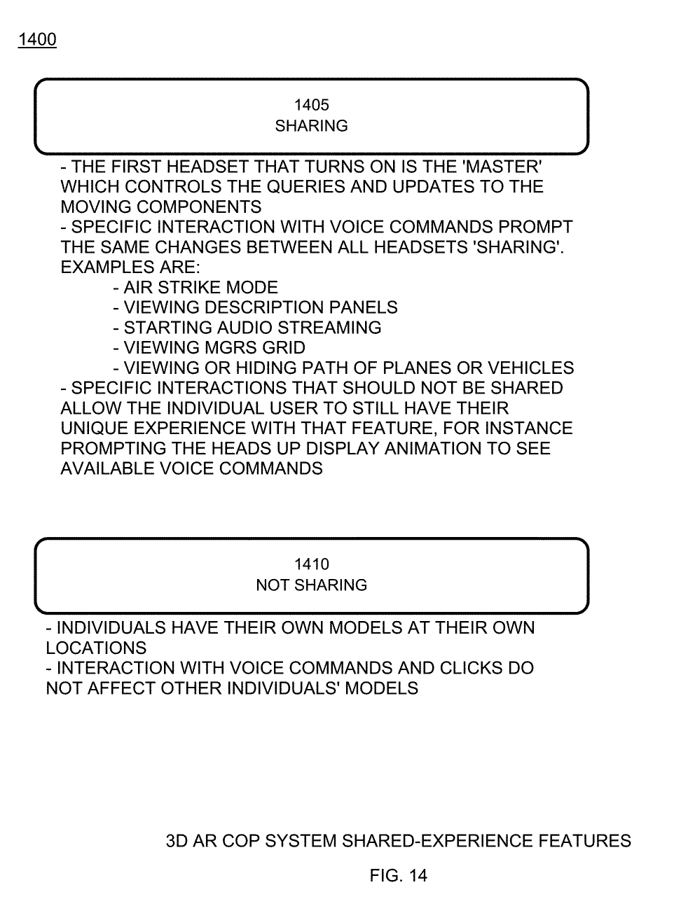

FIG. 14 depicts shared-experience features 1400 for a 3D AR COP system embodiment. Embodiments implement the capability of sharing 1405, so features that are determined to be useful to have multiple entities see reactions at the same time are able to see reactions at the same time. Embodiments are configured to allow one headset to share the same experience with one or multiple other headsets. If this is desired, the first headset to start the application becomes the master, who controls obtaining information from the messaging bus that will populate the screen with relevant information. That headset will disseminate the information. Each user that is participating in sharing can interact with the application so that others will see the reaction to his or her interaction. Examples include prompting air strike mode, viewing description panels of moving vehicles, starting and stopping audio streaming of communications, viewing the MGRS grid overlay, and viewing or hiding paths of vehicles. Certain functionality that is desirable to stay personalized and not be shared 1410 is kept personalized to the individual, like interaction with the Heads Up Display to see voice commands available to the user.

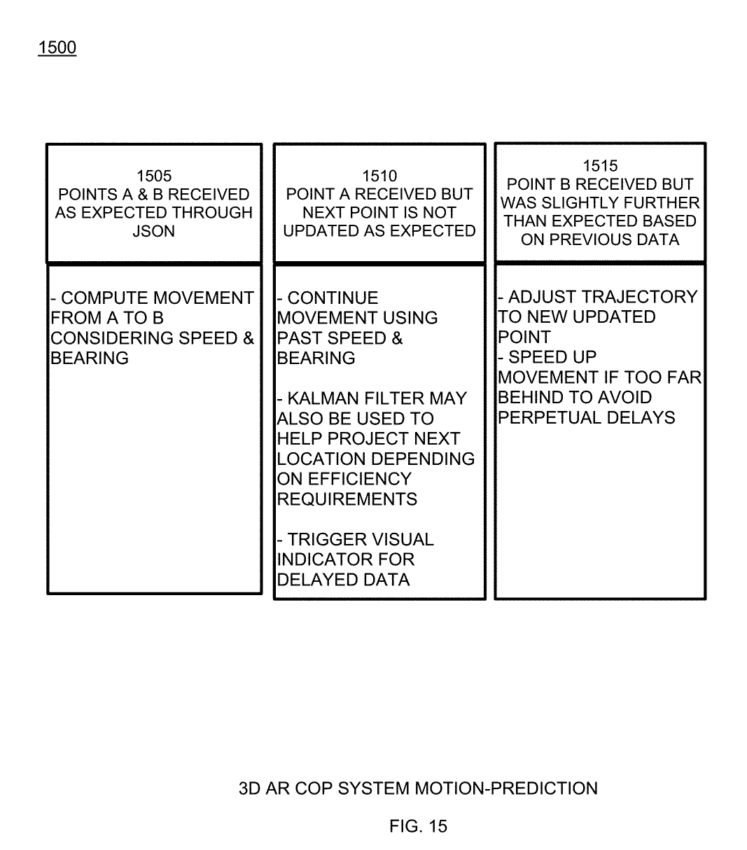

FIG. 15 depicts motion-prediction 1500 for a 3D AR COP system embodiment. Embodiments include a module that does not just create a calculation to go from point to point every time a new packet is received, but will maintain intended flight trajectory based on past movement even if not all packets come in as expected. An indicator displays that the data is not as current as preferred, and part of the module includes a method to ensure that plane would get back on track if the projected path turned out to be different than the actual path once packets did come back in an efficient way that seems smooth to the viewer. Referring to three cases: 1.) points A & B received as expected through JSON 1505, 2.) point A received but next point is not updated as expected 1510, and 3.) point B received but was slightly further than expected based on previous data 1515. For points A & B received as expected through JSON 1505, embodiments compute movement from A to B considering speed & bearing. For point A received but next point is not updated as expected 1510, embodiments continue movement using past speed & bearing; a Kalman filter may also be used to help project next location depending on efficiency requirements, and embodiments trigger a visual indicator for delayed data. For point B received but was slightly further than expected based on previous data 1515, embodiments adjust trajectory to new updated point, and speed up movement if too far behind to avoid perpetual delays.

Embodiments use a Hidden Markov Model to learn and adapt based on identifiable information on the user (rank, billet, location, task at hand, etc.) what kind of information would be relevant to that user. By seeing what changes that individual makes to modify the environment for his needs, which may differ from what the model initially predicted, the model learns and adapts to improve displaying what is relative based on user and mission.

Aspects of the present invention are described herein with reference to a flowchart illustration and block diagram of methods according to embodiments of the invention. It will be understood that blocks of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems and methods according to various embodiments of the present invention. In this regard, each block in the flowchart or block diagrams may represent a module, segment, or portion of instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing description of the embodiments has been presented for the purposes of illustration and description. It is not intended to be exhaustive or to limit the invention to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure. Other and various embodiments will be readily apparent to those skilled in the art, from this description, figures, and the claims that follow. It is intended that the scope of the invention be limited not by this detailed description, but rather by the claims appended hereto.

What is claimed is:

1. A device for a secure, scalable, real-time 3D augmented reality (AR) common operating picture (COP) enabling a plurality of users to see entities in an environment using real-time data to populate movement and characteristics comprising:
a 3D AR COP system;
at least one 3D display to display at least one 3D environment model for said plurality of users in two-way communication with said 3D AR COP system;
at least one said entity in two-way communication with said 3D AR COP system;
a security module controlling said two-way communication between said at least one 3D display and said at least one entity;
said scaling of said 3D AR COP system comprises a Memory Pool and real-time motion-prediction;
real-time external source data comprising monitoring messaging bus packets by said 3D AR COP system;
user input, wherein said user input selects data from said real-time external source data to display in relation to its source.

2. The device of claim 1, wherein said 3D display comprises:
a single shared 3D augmented reality holographic display for a plurality of users.

3. The device of claim 1 wherein said 3D display comprises:
a 3D augmented reality display for each said user.

4. The device of claim 1 wherein said Memory Pool is prepopulated during startup and stored on said real-time 3D AR COP system, said Memory Pool subsequently used by said real-time 3D AR COP as needed, whereby said real-time 3D AR COP is scalable.

5. The device of claim 1 wherein said 3D AR COP system comprises a hybrid-architecture comprising:
an object-oriented architecture encapsulating shared data and functionality among one common parent, which can then be inherited by several children which implement their own unique data and functionalities, reducing the need to duplicate code in multiple areas; and
a component-based architecture, wherein different components are written up in scripts, giving a specific and separated functionality, each of said components is written generically whereby they can be reused to among different objects.

6. The device of claim 1 wherein a segmented-canvas of said 3D AR COP system comprises:
segmented canvases of an entire canvas whereby segmented canvases display information for each said user enabling scaling of updating information by segmenting which parts of said entire canvas get updated.

7. The device of claim 1 wherein a shared-experience feature of said 3D AR COP system comprises:
a first headset designated as a master headset;
one or more headsets controlled by said master headset;
whereby said master headset controls obtaining and disseminating information from said messaging bus to populate shared-experience headset displays with relevant information, whereby each user participating in sharing can interact so that others will see reactions to said each user's interaction.

8. The device of claim 1 wherein said real-time motion-prediction comprises:
displaying predicted paths, based on historic data, when packets are lost, whereby asset movement is smoothly transitioned to an actual location when said packets are received.

9. The device of claim 1 wherein said security module comprises:
corresponding a security level of each of said two-way communication with said 3D AR COP system and said at least one entity to a user-security level of each of said users for a security-selective display to said user.

10. A method for a secure, scalable, real-time 3D augmented reality common operating picture enabling at least one user to see entities in an environment using real-time data to populate movement and characteristics comprising:
identifying an environment;
selecting a 3D model for said environment;
populating a Memory Pool, whereby said real-time 3D augmented reality common operating picture is scalable;
generating said 3D environment from said 3D model;
displaying said 3D environment;
selecting a plurality of external data sources;
inputting said external data sources;
filtering display information in a security module;
displaying at least one moving object asset from said external data sources in said 3D environment;
accepting input from said at least one user;
displaying a data panel representing said characteristics in response to said input; and
updating said real-time data comprising monitoring messaging bus packets.

11. The method of claim 10 comprising:
test scenario capabilities whereby equipment is evaluated;
mission planning capabilities wherein said real-time data is simulated; and
live mission capabilities wherein active components are determined by actual real-time data, and assets are directed through bidirectional communications with them.

12. The method of claim 10 comprising:
mission planning capabilities comprising displaying and comparing different routes.

13. The method of claim 10 comprising:
displaying locations of interest, wherein data of said locations is displayed in both Latitude/Longitude (Lat/Long) and Military Grid Reference System (MGRS); and
wherein said external source data comprises at least one of air platform real-time data; land platform real-time data; and sea platform real-time data.

14. The method of claim 10 comprising:
displaying locations of interest comprising past TED attacks, known hostile regions, air support locations, and route travel repetition; and
displaying lethality of weapons from moving components, said lethality comprising projected air strikes from a moving aircraft and artillery from troops.

15. The method of claim 10 comprising:
comparing and contrasting a time range needed to travel a route, projected danger of each said route, and obstacles expected along said route.

16. The method of claim 10 comprising a radar display for a minimized view of moving components.

17. The method of claim 10 wherein said 3D display comprises:
identifying which assets are involved in the same mission; and
said data panel display comprises:
fuel levels for tanks and aircraft, and food rations for ground troops.

18. The method of claim 10 comprising:
machine learning whereby a user is allowed to only see what information is relevant to that individual; and
displaying a text breakdown of battlefield relevance of entities that are currently in a space, selected from the group consisting of friendly, enemy, ally, and avoid;
wherein a Hidden Markov Model learns and adapts based on identifiable information on said user.

19. The method of claim 10 wherein said security module comprises:
display control comprising a role of said user, wherein said role comprises a security clearance level of each said user;
filtering of said at least one 3D environment model and said real-time external source data according to a security level assigned to each, whereby each of said users is presented only said model and said source data at or below said security clearance level of each said user; and
for a shared-display, only said model and said source data at or below said security clearance level of said user having a lowest security level is displayed.

20. A system for a secure, scalable, real-time 3D augmented reality (AR) common operating picture (COP) enabling a plurality of users to see entities in an environment using real-time data to populate movement and characteristics comprising:
at least one 3D augmented reality device;
at least one processor;
in said at least one processor:
organizing folders outputting JSON format data;
populating a memory pool, whereby said real-time 3D augmented reality common operating picture is scalable;
said folders comprising service engines folder, holograms folder, and 2525 symbol library folder, wherein said folders are expandable by adding new source data pipes and service engines;
wherein input to said folders comprises external source data pipes providing input to at least one Combat ID Server which provides output to a prestrike IFF;
wherein output from said folders comprises 3D-GEO, ADS-B, FBCB-2, TADIL-J, C-RAM, and weather;
wherein each of said ADS-B, FBCB-2, TADIL-J, C-RAM, and weather comprises JSON output;
wherein said 3D-GEO output comprises at least one geographic region;
wherein output from said folders comprises JSON format data;
wherein a user selects appropriate service engines in a resident cop application; and
in a topology no data is retained in said augmented reality device, only a core COP application remains resident, all working data is pulled from said combat ID (CID) server when needed by selected service engines; and
an auto zero is executed at power off.
